(19) United States
(12) Patent Application Publication
(10) Pub. No.: US 2012/0133584 A1
(43) Pub. Date: May 31, 2012

(54) Apparatus and method for calibrating 3D position in 3D position and orientation tracking system

(75) Inventors: Hyong Euk Lee, Yongin-si (KR); Won Chul Bang, Bundang-gu (KR); Sang Hyun Kim, Hwaseong-si (KR); Jung Bae Kim, Hwaseong-si (KR)

(73) Assignee: SAMSUNG ELECTRONICS CO., LTD., Suwon-si (KR)

(21) Appl. No.: 13/137,633

(22) Filed: Aug. 30, 2011

(30) Foreign Application Priority Data
Nov. 30, 2010 (KR) 10-2010-0120270

(51) Int. Cl. G06F 3/033; G06F 19/00

(52) U.S. Cl. 345/158; 702/94

(57) ABSTRACT

An apparatus and method for calibrating a 3D position in a 3D position and orientation tracking system are provided. The apparatus according to an embodiment may track the 3D position and the 3D orientation of a remote device in response to a detection of a pointing event, may acquire positions pointed to by the laser beams, in response to the detection of the pointing event, may generate a 3D reference position, based on information about the pointed to positions and the tracked 3D orientation, may calculate an error using the reference position and the tracked 3D position, and may calibrate the 3D position to be tracked, using the error.

### CROSS-REFERENCE TO RELATED APPLICATIONS

This application claims the benefit of Korean Patent Application No. 10-2010-0120270, filed on Nov. 30, 2010, in the Korean Intellectual Property Office, the disclosure of which is incorporated herein by reference.

### BACKGROUND

1. Field

One or more example embodiments of the present disclosure relate to an apparatus and method for calibrating a three-dimensional (3D) position in a 3D position and orientation tracking system.

2. Description of the Related Art

A technology for tracking a three-dimensional (3D) position and orientation of a moving object or target has typically been used for sensing a motion of an object, a body, an animal, and the like in a 3D space, using a large motion capture equipment at a high cost in a movie, graphics, and animation industry, and the like.

However, a motion sensing technology for consumer electronics related to the gaming industry has started to command attention, leading to a development of a number of 3D position and orientation tracking schemes using small-sized motion capture at a low cost.

A 3D position may be calibrated to track an accurate 3D position.

In the case of a touch panel and the like where a target interface device operates by way of a touch on a two-dimensional (2D) plane, a position may be easily and accurately calibrated by touching a reference point. However, a 3D position and orientation tracking system in a 3D space may have difficulty in calibrating a position without a high precision system providing separate reference information.

### SUMMARY

The foregoing and/or other aspects are achieved by providing an apparatus for calibrating a three dimensional (3D) position of a remote device in a 3D position and orientation tracking system, the apparatus including a beam generating unit to generate at least two laser beams outputted in different orientations at predetermined angles, a position tracking unit to track a 3D position of the remote device in response to a detection of a pointing event, an orientation tracking unit to track a 3D orientation of the remote device in response to the detection of the pointing event, a pointing position acquiring unit to acquire positions pointed to by the at least two laser beams, in response to the detection of the pointing event, a reference position generating unit to generate a 3D reference position, based on information about the pointed to positions and the tracked 3D orientation, an error calculating unit to calculate an error using the reference position and the tracked 3D position, and a position calibrating unit to calibrate the 3D position tracked by the position tracking unit, using the error.

The orientation tracking unit may track a trajectory of the 3D orientation of the remote device in response to the detection of the pointing event, the pointing position acquiring unit may acquire a trajectory pointed to by the at least two laser beams, in response to the detection of the pointing event, and the reference position generating unit may generate the 3D reference position, using the pointed trajectory and the tracked trajectory of the 3D orientation.

The pointing event may correspond to an event simultaneously pointing to points corresponding to a number of the laser beams using the at least two laser beams.

The pointing event may correspond to an event that points to, using the at least two laser beams, straight lines corresponding to a number of the laser beams along the straight lines.

The pointing position acquiring unit may receive a position of reference points from a display device displaying the reference points, and acquire the position of the reference points as the pointed to positions.

The pointing position acquiring unit may acquire the pointed to positions from a sensor measuring a position pointed to by a laser beam.

The foregoing and/or other aspects are achieved by providing an apparatus for calibrating a 3D position of a remote device in a 3D position and orientation tracking system, the apparatus including a beam generating unit to generate at least one laser beam, an event detecting unit to detect at least three instances of pointing events, a position tracking unit to track a 3D position of the remote device, in response to the detection of the pointing events, an orientation tracking unit to track a 3D orientation of the remote device, in response to the detection of the pointing events, a pointing position acquiring unit to acquire a position pointed to by the at least one laser beam, in response to the detection of the pointing events, a reference position generating unit to generate a 3D reference position, based on information about the pointed to positions and the tracked 3D orientation, an error calculating unit to calculate an error using the reference position and the tracked 3D position, and a position calibrating unit to calibrate the 3D position tracked by the position tracking unit, using the error.

The orientation tracking unit may track a trajectory of the 3D orientation of the remote device in response to the detection of the pointing events, the pointing position acquiring unit may acquire a pointed to trajectory, in response to the detection of the pointing events, and the reference position generating unit may generate the 3D reference position, using the pointed to trajectory and the tracked trajectory of the 3D orientation.

The pointing events may correspond to events that point to points displayed on a display device using the at least one laser beam.

The pointing events may correspond to events that point to, using the at least one laser beam, a straight line outputted from a display device along the straight line.

The pointing position acquiring unit may receive a position of a reference point from a display device displaying the reference point, and acquire the position of the reference point as the pointed to position.

The pointing position acquiring unit may acquire the pointed to position from a sensor measuring a position pointed to by a laser beam.

The foregoing and/or other aspects are achieved by providing a method of calibrating a 3D position of a remote device in a 3D position and orientation tracking system, the method including tracking a 3D position of the remote device in response to a detection of a pointing event, tracking a 3D orientation of the remote device in response to the detection of the pointing event, acquiring positions pointed to by the at least two laser beams outputted in different orientations at predetermined angles, in response to the detection of the pointing event, generating a 3D reference position, based on information about the pointed to positions and the tracked 3D orientation, calculating an error using the reference position and the tracked 3D position, and calibrating the 3D position to be tracked, using the error.

The pointing event may correspond to an event simultaneously pointing to points corresponding to a number of the laser beams using the at least two laser beams.

The pointing event may correspond to an event that points to, using the at least two laser beams, straight lines corresponding to a number of the laser beams along the straight lines.

The foregoing and/or other aspects are achieved by providing a method of calibrating a 3D position of a remote device in a 3D position and orientation tracking system, the method including tracking a 3D position of the remote device in response to a detection of a pointing event, tracking a 3D orientation of the remote device in response to the detection of the pointing event, acquiring a position pointed to by a laser beam, in response to the detection of the pointing event, repeating the acquiring of the pointed to position at least three times in the tracking of the 3D position of the remote device, generating a 3D reference position, based on information about the pointed to position and the tracked 3D orientation, calculating an error using the 3D reference position and the tracked 3D position, and calibrating the 3D position to be tracked, using the error.

The pointing event may correspond to an event pointing to a point displayed on a display device using the laser beam.

The pointing event may correspond to an event that points to, using the laser beam, a straight line outputted from a display device along the straight line.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates a configuration of an apparatus for calibrating a three-dimensional (3D) position in a 3D position and orientation tracking system according to example embodiments;

FIG. 2 illustrates an example of performing a pointing using a single laser beam to calibrate a 3D position;

FIG. 3 illustrates an example of performing a pointing using two laser beams to calibrate a 3D position;

FIGS. 4A, 4B, and 4C illustrate an example of a point or a straight line pointed to by two laser beams during a pointing event for calibrating a position; and

FIG. 5 illustrates an operational flowchart for calibrating a 3D position in a 3D position and orientation tracking system according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

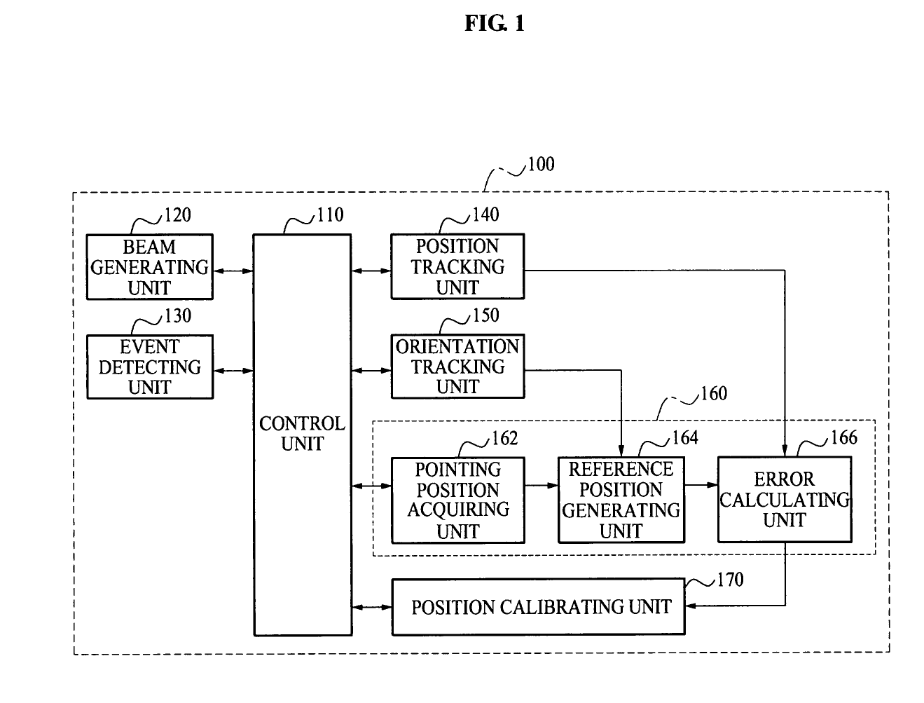

FIG. 1 illustrates a configuration of an apparatus 100 for calibrating a three-dimensional (3D) position in a 3D position and orientation tracking system according to example embodiments.

Referring to FIG. 1, the apparatus 100 for calibrating a 3D position may include, for example, a control unit 110, a beam generating unit 120, an event detecting unit 130, a position tracking unit 140, an orientation tracking unit 150, an initial calibrating unit 160, and a position calibrating unit 170.

The beam generating unit 120 may generate a laser beam. The beam generating unit 120 may generate a single laser beam, or at least two laser beams outputted in different orientations at predetermined angles. Note that, the laser beam may correspond to a light source having a characteristic of straightness. The beam generating unit 120 may include at least one laser such as a laser pointer or a laser diode to generate the laser beam.

The event detecting unit 130 may detect a pointing event. The event detecting unit 130 may correspond to an input device and may detect an input by a user. The user may point the laser beam to an accurate position and may thereby generate an event reporting the pointing through the input.

The position tracking unit 140 may track a 3D position of a remote device. The position tracking unit 140 may track the 3D position of the remote device using a camera, using an infrared light, using an inertial sensor, or using an attenuation characteristic of a light-emitting and receiving signal according to a directivity of an infrared signal. Here, the apparatus 100 for calibrating a 3D position may be disposed inside the remote device or may be disposed outside the remote device.

The orientation tracking unit 150 may track a 3D orientation of the remote device.

The orientation tracking unit 150 may track the 3D orientation through the inertial sensor. The inertial sensor may be configured as a combination including at least one of an acceleration sensor, a gyro sensor, and a geomagnetic sensor. Thus, the tracking of the orientation thorough the inertial sensor may be appropriate to an orientation tracking for calibrating an initial position.

The initial calibrating unit 160 may calculate an error of a current 3D position based on information about a pointed to position, the 3D position, and the 3D orientation. The initial calibrating unit 160 may include a pointing position acquiring unit 162, a reference position generating unit 164, and an error calculating unit 166. The initial calibrating unit 160 may operate differently depending on a number of laser beams outputted from the beam generating unit 120.

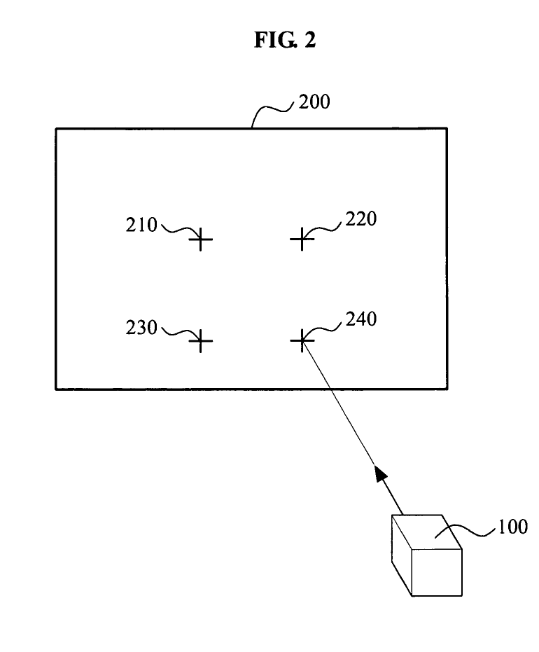

A case where the number of laser beams outputted from the beam generating unit 120 corresponds to one will be described with reference to FIG. 2. FIG. 2 illustrates an example of performing a pointing event using a single laser beam to calibrate a 3D position. In FIG. 2, the apparatus 100 for calibrating a 3D position may be disposed inside the remote device.

Where the number of laser beams outputted from the beam generating unit 120 corresponds to one, the remote device may perform a pointing event by outputting a laser beam while changing an orientation at the same position to calibrate a 3D position.

Referring to FIG. 2, the pointing position acquiring unit 162 (not shown) may acquire positions of reference points 210, 220, 230, and 240 from a display device 200 each time the reference points 210, 220, 230, and 240 are sequentially pointed to through the display device 200.

The pointing position acquiring unit 162 may acquire the positions of the reference points 210, 220, 230, and 240 corresponding to positions pointed to from the display device 200, or from a sensor for measuring a position pointed to by the laser beam. Here, the sensor measuring the laser beam may be configured to be included in a display panel of the display device 200, although the sensor may alternatively be located elsewhere.

The reference position generating unit 164 may generate a 3D reference position based on information about the positions of the reference points 210, 220, 230, and 240 as well as a 3D direction tracked during a pointing event.

The error calculating unit 166 may calculate an error using a difference between a reference position generated by the reference position generating unit 164 and a 3D position tracked by the position tracking unit 140.

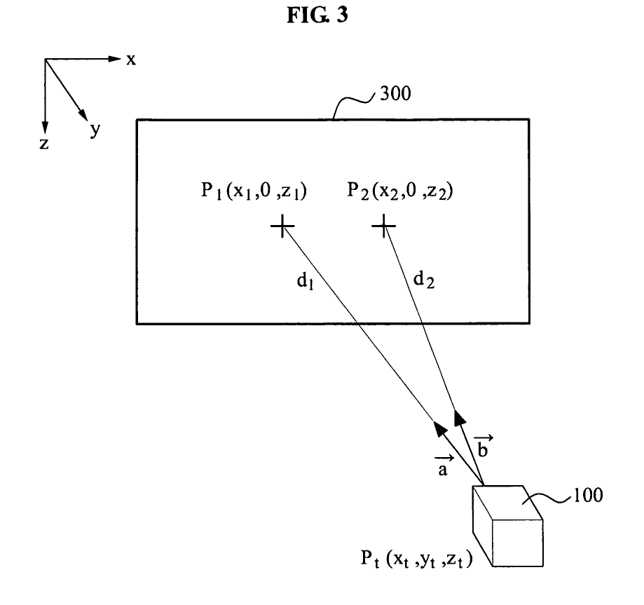

Next, a case in which the number of laser beams outputted from the beam generating unit 120 corresponds to at least two will be described with reference to FIG. 3. FIG. 3 illustrates an example of performing a pointing event using two laser beams to calibrate a 3D position. In FIG. 3, the apparatus 100 for calibrating a 3D position may be disposed inside the remote device, although the apparatus 100 may alternatively be located elsewhere.

The pointing position acquiring unit 162 may acquire positions P₁ and P₂ pointed to by laser beams, in response to a detection of a pointing event. The pointing position acquiring unit 162 may acquire the pointed to positions P₁ and P₂ from a display device 300, or from a sensor for measuring a position pointed to by the laser beams.

The reference position generating unit 164 may generate a 3D reference position based on information about locations of the pointed to positions P₁ and P₂ and a 3D orientation tracked during the pointing event.

A relationship between two laser beams outputted in different orientations at predetermined angles and the 3D orientation may be expressed by the following Equation 1.

\vec{a}=R·\vec{a}₀

\vec{b}=R·\vec{b}₀ [Equation 1]

Here, \vec{a} corresponds to a unit vector in a direction of a first laser beam transformed by a rotation matrix, \vec{b} corresponds to a unit vector in a direction of a second laser beam transformed by a rotation matrix, \vec{a}₀ corresponds to a reference value and to a unit vector in a direction of the first laser beam before a transformation by the rotation matrix, \vec{b}₀ corresponds to a reference value and to a unit vector in a direction of the second laser beam before a transformation by the rotation matrix, and R corresponds to a rotation transformation matrix. R may be expressed by the following Equation 2.

$$R = [ \begin{matrix}CyCz & - CySz & Sy \\ SxSyCz + CxSz & - SxSySz + CxCz & - SxCy \\ - CxSyCz + SxSz & CxSySz + SxCz & CxCy\end{matrix} ] , \\ where \\ Cx = cos ( ϕ ) , Sx = sin ( ϕ ) , Cy = cos ( θ ) , \\ Sy = sin ( θ ) , Cz = cos ( ψ ) , Sz = sin ( ψ ) . \qquad [ Equation 2 ]$$

Here, φ corresponds to a rotation angle of a roll, θ corresponds to a rotation angle of a pitch, and ψ corresponds to a rotation angle of a yaw.

When it is assumed that the pointed to position P₁ corresponds to (x₁, 0, z₁), the pointed to position P₂ corresponds to (x₂, 0, z₂), a reference position Pₜ to be calculated corresponds to (xₜ, yₜ, zₜ), a distance between apparatus 100 and the position P₁ corresponds to d₁, and a distance between apparatus 100 and the position P₂ corresponds to d₂, Equation 3 may be expressed as shown below. It should be noted that even though values on y-axis of the pointed to positions P₁ and P₂ are set to “0” for convenience, the values may not be limited to

d₁·\vec{a}=(x₁−xₜ,−yₜ,z₁−zₜ)

d₂·\vec{b}=(x₂−xₜ,−yₜ,z₂−zₜ) [Equation 3]

When simultaneous equations are solved using Equation 3, the reference position may be generated as shown in the following Equation 4.

xₜ=x₁−d₁aₓ

yₜ=−d₁a_{y}

zₜ=z₁d₁a_{z} [Equation 4]

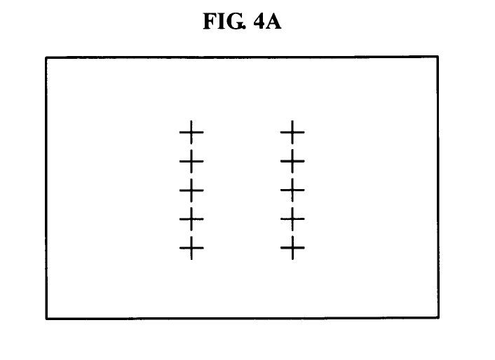

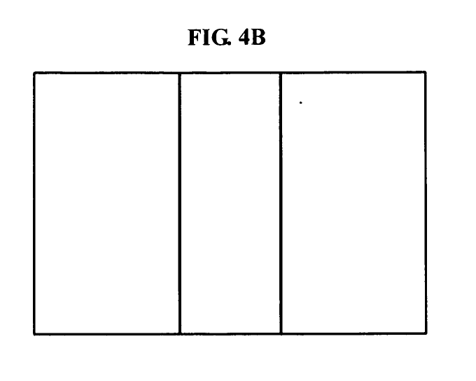

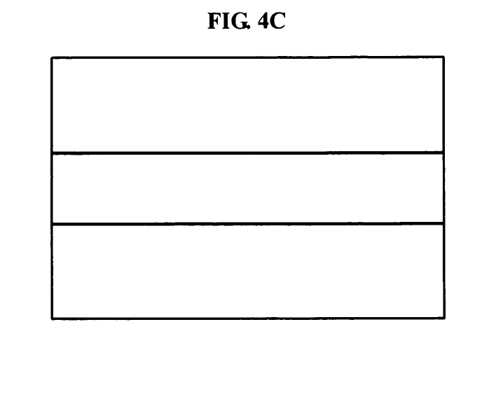

The error calculating unit 166 may calculate an error using a difference between the reference position generated by the reference position generating unit 164 and the 3D position tracked through the position tracking unit 140.

Where the number of laser beams outputted from the beam generating unit 120 corresponds to at least two, the pointing event may occur as illustrated in FIGS. 4A, 4B, and 4C.

FIGS. 4A, 4B, and 4C illustrate an example of a point or a straight line pointed to by two laser beams during a pointing event for calibrating a position.

The pointing event may occur in a straight line as illustrated in FIG. 4B or FIG. 4C.

In a case where the pointing event occurs in a straight line, the orientation tracking unit 150 may track a trajectory of a 3D orientation of the remote device.

In a case where the pointing event occurs in a straight line, the pointing position acquiring unit 162 may acquire a trajectory pointed to by way of the laser beams.

In a case where the pointing event occurs in a straight line, the reference position generating unit 164 may generate a 3D reference position using pointed to trajectories and tracked trajectories of a 3D orientation.

Referring to FIG. 2, the position calibrating unit 170 may calibrate a 3D position tracked through the position tracking unit 140 in real time, using an error calculated through the error calculating unit 166. The position calibrating unit 170 may perform an offset calibration offsetting an error or may perform a scale factor calibration using an error.

The offset calibration may be expressed by Equation 5, and the scale factor calibration may be expressed by Equation 6.

\hat{x}=x−Δx

ŷ=y−Δy

\hat{z}=z−Δz [Equation 5]

Here, (\hat{x}, ŷ, \hat{z}) corresponds to a calibrated 3D position value, (x, y, z) corresponds to a 3D position value before a calibration, and (Δx, Δy, Δz) corresponds to an error value.

\hat{x}={(x₀−Δx₀)/x₀}·x

ŷ={(y₀−Δy₀)/y₀}·y

\hat{z}={(z₀−Δz₀)/z₀}·z [Equation 6]

Here, (\hat{x}, ŷ, \hat{Z}) corresponds to a calibrated 3D position value, (x, y, z) corresponds to a 3D position value before a calibration, (x₀, y₀, z₀) corresponds to a 3D position value tracked during the pointing event to generate a reference position, and (Δx₀, Δy₀, Δz₀) corresponds to an error value calculated by a difference between (x₀, y₀, z₀) and the reference position. The control unit 110 may control an overall operation of the apparatus 100. The control unit 110 may perform a function of the pointing position acquiring unit 162, the reference position generating unit 164, the error calculating unit 166, and the position calibrating unit 170. The control unit 110, the pointing position acquiring unit 162, the reference position generating unit 164, the error calculating unit 166, and the position calibrating unit 170 are separately illustrated so as to separately describe each function. Thus, the control unit 110 may include at least one processor configured to perform each function of the pointing position acquiring unit 162, the reference position generating unit 164, the error calculating unit 166, and the position calibrating unit 170. The control unit 110 may include at least one processor configured to perform a at least a portion of each function of the pointing position acquiring unit 162, the reference position generating unit 164, the error calculating unit 166, and the position calibrating unit 170.

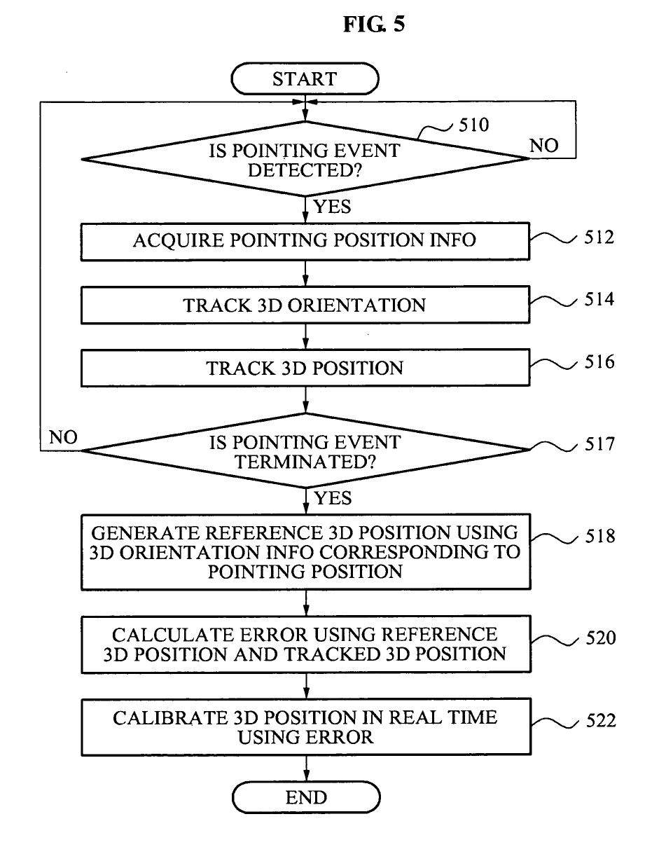

Hereinafter, a method of calibrating a 3D position in a 3D position and orientation tracking system according to an embodiment configured as above will be described with reference to FIG. 5.

Since a more accurate 3D position may be tracked when at least two laser beams are simultaneously outputted in comparison with a case where one laser beam is outputted, the method of calibrating a 3D position will be described for a case where the number of laser beams corresponds to at least two.

FIG. 5 illustrates an operational flowchart for calibrating a 3D position in a 3D position and orientation tracking system according to example embodiments.

Referring to FIG. 5, when a pointing event is detected in operation 510, the apparatus 100 may acquire positions pointed to by the at least two laser beams outputted in different orientations at predetermined angles in operation 512. Note that the pointing event may simultaneously correspond to another event by simultaneously pointing to points corresponding to a number of the laser beams using the at least two laser beams. Also, the pointing event may correspond to an event that points to, using the at least two laser beams, straight lines corresponding to the number of the laser beams along the straight lines.

In operation 514, the apparatus 100 may track a 3D position of a remote device in response to a detection of the pointing event.

In operation 516, the apparatus 100 may track a 3D orientation of the remote device in response to a detection of the pointing event.

In operation 517, the apparatus 100 may verify whether the pointing event is terminated. The pointing event may be terminated when sufficient information for calibrating the 3D position is acquired. Whether the pointing event is terminated may be verified by determining whether the pointing event is performed a predetermined number of times.

In operation 518, the apparatus 100 may generate a 3D reference position, based on information about pointed to positions and the tracked 3D orientation.

In operation 520, the apparatus 100 may calculate an error using the reference position and the tracked 3D position.

In operation 522, the apparatus 100 may calibrate the 3D position to be tracked, using the error.

The aforementioned example embodiments relate to an apparatus and method for calibrating a 3D position in a 3D position and orientation tracking system, and may enable a stable sensing function by calibrating an error of the 3D position occurring due to a function deviation between a sensor and a device in mass production or in a process of manufacturing a product.

The methods according to the above-described example embodiments may be recorded in non-transitory computer-readable media or processor-readable media including program instructions to implement various operations embodied by a computer or processor. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer or processor using an interpreter. The described hardware devices may be configured to act as one or more software modules in order to perform the operations of the above-described example embodiments, or vice versa. Any one or more of the software modules described herein may be executed by a dedicated processor unique to that unit or by a processor common to one or more of the modules. The described methods may be executed on a general purpose computer or processor or may be executed on a particular machine such as the apparatus for calibrating a 3D position of a remote device in a 3D position and orientation tracking system described herein.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for calibrating a three dimensional (3D) position of a remote device in a 3D position and orientation tracking system, the apparatus comprising:
a beam generating unit to generate at least two laser beams;
a position tracking unit to track a 3D position of the remote device in response to a detection of a pointing event;
an orientation tracking unit to track a 3D orientation of the remote device in response to the detection of the pointing event;
a pointing position acquiring unit to acquire positions pointed to by the at least two laser beams in response to the detection of the pointing event;
a reference position generating unit to generate a 3D reference position based on information about the pointed to positions and the tracked 3D orientation;
an error calculating unit to calculate an error using the reference position and the tracked 3D position; and
a position calibrating unit to calibrate the 3D position tracked by the position tracking unit, using the calculated error.

2. The apparatus of claim 1, wherein:
the orientation tracking unit tracks a trajectory of the 3D orientation of the remote device in response to the detection of the pointing event,
the pointing position acquiring unit acquires a trajectory pointed to by the at least two laser beams, in response to the detection of the pointing event, and
the reference position generating unit generates the 3D reference position, using the pointed to trajectory and the tracked trajectory of the 3D orientation.

3. The apparatus of claim 1, wherein the pointing event corresponds to an event simultaneously pointing to points corresponding to a number of the laser beams using the at least two laser beams.

4. The apparatus of claim 1, wherein the pointing event corresponds to an event that points to, using the at least two laser beams, straight lines corresponding to a number of the laser beams along the straight lines.

5. The apparatus of claim 1, wherein the pointing position acquiring unit receives a position of reference points from a display device displaying the reference points, and acquires the position of the reference points as the pointed to positions.

6. The apparatus of claim 1, wherein the pointing position acquiring unit acquires the pointed to positions from a sensor measuring a position pointed to by a laser beam.

7. The apparatus of claim 1, wherein the orientation tracking unit tracks the 3D orientation of the remote device using at least one of an acceleration sensor, a gyro sensor, and a geomagnetic sensor.

8. The apparatus of claim 1, wherein the beam generating unit outputs the at least two laser beams in different orientations at predetermined angles.

9. An apparatus for calibrating a three dimensional (3D) position of a remote device in a 3D position and orientation tracking system, the apparatus comprising:
a beam generating unit to generate at least one laser beam;
an event detecting unit to detect at least three instances of pointing events;
a position tracking unit to track a 3D position of the remote device, in response to the detection of the pointing events;
an orientation tracking unit to track a 3D orientation of the remote device, in response to the detection of the pointing events;
a pointing position acquiring unit to acquire a position pointed to by the at least one laser beam, in response to the detection of the pointing events;
a reference position generating unit to generate a 3D reference position based on information about the pointed to positions and the tracked 3D orientation;
an error calculating unit to calculate an error using the reference position and the tracked 3D position; and
a position calibrating unit to calibrate the 3D position tracked by the position tracking unit using the calculated error.

10. The apparatus of claim 9, wherein:
the orientation tracking unit tracks a trajectory of the 3D orientation of the remote device in response to the detection of the pointing events,
the pointing position acquiring unit acquires a pointed to trajectory, in response to the detection of the pointing events, and
the reference position generating unit generates the 3D reference position, using the pointed to trajectory and the tracked trajectory of the 3D orientation.

11. The apparatus of claim 9, wherein the pointing events correspond to events that point to points displayed on a display device using the at least one laser beam.

12. The apparatus of claim 9, wherein the pointing events correspond to events that point to, using the at least one laser beam, a straight line outputted from a display device along the straight line.

13. The apparatus of claim 9, wherein the pointing position acquiring unit receives a position of a reference point from a display device displaying the reference point and acquires the position of the reference point as the pointed to position.

14. The apparatus of claim 9, wherein the pointing position acquiring unit acquires the pointed to position from a sensor measuring a position pointed to by a laser beam.

15. The apparatus of claim 9, wherein the orientation tracking unit tracks the 3D orientation of the remote device using at least one of an acceleration sensor, a gyro sensor, and a geomagnetic sensor.

16. A method of calibrating a three dimensional (3D) position of a remote device in a 3D position and orientation tracking system, the method comprising:
tracking a 3D position of the remote device in response to a detection of a pointing event;
tracking a 3D orientation of the remote device in response to the detection of the pointing event;
acquiring positions pointed to by at least two laser beams in response to the detection of the pointing event;
generating a 3D reference position based on information about the pointed to positions and the tracked 3D orientation;
calculating, by way of a processor, an error using the reference position and the tracked 3D position; and
calibrating the 3D position to be tracked using the calculated error.

17. The method of claim 16, wherein the pointing event corresponds to an event simultaneously pointing to points corresponding to a number of the laser beams using the at least two laser beams.

18. The method of claim 16, wherein the pointing event corresponds to an event that points to, using the at least two laser beams, straight lines corresponding to a number of the laser beams along the straight lines.

19. The method of claim 16, wherein the at least two laser beams are output in different orientations at predetermined angles.

20. A non-transitory computer-readable storage medium encoded with computer readable code for implementing the method of claim 16.

21. A method of calibrating a three dimensional (3D) position of a remote device in a 3D position and orientation tracking system, the method comprising:
tracking a 3D position of the remote device in response to a detection of a pointing event;
tracking a 3D orientation of the remote device in response to the detection of the pointing event;
acquiring a position pointed to by a laser beam in response to the detection of the pointing event;
repeating the acquiring of the pointed to position at least three times in the tracking of the 3D position of the remote device;
generating a 3D reference position, based on information about the pointed to position and the tracked 3D orientation;
calculating, by way of a processor, an error using the 3D reference position and the tracked 3D position; and
calibrating the 3D position to be tracked using the calculated error.

22. The method of claim 21, wherein the pointing event corresponds to an event pointing to a point displayed on a display device using the laser beam.

23. The method of claim 21, wherein the pointing event corresponds to an event that points to, using the laser beam, a straight line outputted from a display device along the straight line.

24. A non-transitory computer-readable storage medium encoded with computer readable code for implementing the method of claim 21.
